(19) United States
(12) Patent Application Publication
(10) Pub. No.: US 2011/0221082 A1
(43) Pub. Date: Sep. 15, 2011

(54) LIPOSOME MANUFACTURING DEVICE

(75) Inventors: Tetsuro Yoshimura, Mie (JP); Kanta Tsumoto, Mie (JP); Masatoshi Hashimoto, Mie (JP); Toshihiko Yamagata, Tokyo (JP); Kunitate Aoki, Mie (JP)

(73) Assignee: Hashimoto Electronic Industry Co., Ltd., Matsusaka-shi. Mie (JP)

(21) Appl. No.: 13/123,680

(22) PCT Filed: Oct. 9, 2009
(86) PCT No.: PCT/JP2009/067596

§ 371 Date: May 27, 2011

(30) Foreign Application Priority Data
Oct. 10, 2008 (JP) 2008-264135

(51) Int. Cl. B29C 35/02

(52) U.S. Cl. 264/4; 425/5

(57) ABSTRACT

Provided is a liposome manufacturing device which is a relatively small, multipurpose liposome manufacturing device that uses a motor, and that can reliably manufacture various types of liposomes and reconfigured liposomes. The multipurpose liposome manufacturing device is provided with an eccentric motor (3) that generates a vortex flow in a solution held inside a reaction space (2A), a heater (15), an aqueous solution line (6A) that can introduce an aqueous solution into the reaction space, a first bottle (9) that holds the aqueous solution, a first pump (14A) that moves the aqueous solution, an inert gas line (7B) that can introduce nitrogen gas into the reaction space, a decompression line (7B) that decompresses the reaction space, a vacuum pump (21) that decompresses the decompression line, a lipid line (6B) that can introduce an organic solvent in which a lipid is dissolved into the reaction space, a second bottle (10) that holds the organic solvent, and a second pump (14B) that moves the organic solvent to the reaction space through the lipid line (6B). The inert gas is introduced into a reaction vessel (2), the motor (3) is driven, and inside the reaction space (2A), while a vortex flow is generated in the organic solvent in which the lipid held in the reaction space (2A) is dissolved, the vacuum pump (21) is driven, the reaction space (2A) is decompressed to gasify the organic solvent from the reaction space (2A), and a thin lipid film is prepared on the inside wall of the reaction vessel (2). The inert gas is then introduced into the reaction space (2A), and the aqueous solution is added to the thin lipid film, the motor (3) is driven to generate a vortex flow in the aqueous solution, and liposomes are produced.

### TECHNICAL FIELD

The present invention relates to a liposome manufacturing device using an eccentric motor.

### BACKGROUND ART

Liposomes are closed vesicles composed of a lipid bilayer membrane. Liposomes resembling the biological membrane have been used as a variety of research materials to date. Water-soluble active ingredients, antibodies, enzymes, genes and so on may be enclosed in the aqueous phase of liposomes. Also, oil-soluble proteins, active ingredients and so on may be kept in the bilayer membrane of liposomes. Also DNAs or RNAs may be bound to the surface of the bilayer membrane of liposomes. Hence, liposomes have been utilized in fields including medical services, cosmetics, food and so on.

Thorough research into the use of liposome formulations for drug delivery systems (DDS) is recently ongoing. Also proteins or peptides are incorporated in the lipid bilayer membrane of liposomes, and thus evaluation of the actions of such proteins is being studied.

Examples of methods of manufacturing liposomes are known to include vortex treatment, ultrasonic treatment, reverse-phase evaporation, ethanol injection, extrusion, surfactant treatment, and static hydration (Non-Patent documents 1, 2). These manufacturing methods are selected between depending on the structure of liposomes. In particular, ultrasonic treatment which has been used to date since the beginning of research into liposomes is an effective liposome manufacturing method, and so a liposome manufacturing device is being developed using this method (Patent document 1). Also, a liposome manufacturing device using a super-critical fluid is being developed (Patent document 2).

### CITED REFERENCE

### Patent Document

Patent document 1: Japanese Unexamined Patent Publication No. Hei. 4-293537
Patent document 2: Japanese Unexamined Patent Publication No. 2005-162702

### Non-Patent Document

Non-Patent document 1: Hiroshi TERADA, Tetsuro YOSHIMURA, [Liposome test manual in life science], Springer-Verlag Tokyo (1992)
Non-Patent document 2: V. P. Torchilin, V. Weissig, “Liposomes”, Oxford University Press (2003)

### SUMMARY OF INVENTION

### Technical Problem

The liposome manufacturing device that uses ultrasonic treatment disclosed in Patent document 1 is problematic because only a small amount of the solution to be ultrasonically treated can be used, and the temperature of the solution is increased by ultrasonic treatment, undesirably decomposing or denaturing the material. The liposome manufacturing device using a super-critical fluid disclosed in Patent document 2 is problematic because it needs a vessel which endures high pressure and so is bulky.

Because of such problems, the formulation of liposomes should currently mainly depend on manual works. Liposomes are manually formulated in such a manner that the lipid of liposomes is first dissolved in an organic solvent thus preparing a lipid-organic solvent solution, which is then placed in a flask, the inside of the flask is decompressed while rotating the flask, so that the organic solvent is gradually gasified, thereby forming a thin lipid film on the inner wall of the flask. In this manufacturing method, the formation of a uniform thin lipid film is regarded as important in order to formulate liposomes having good quality. Hence, a round-bottom flask having as large a bottom area as possible is used. In the above methods, in order to widely spread the thin lipid film, a large amount of organic solvent is used, which is environmentally unfriendly.

Manufacturing of the thin lipid film using the above methods requires much effort and time. So, a large work force is necessary to manufacture many kinds of liposomes.

Accordingly, the present invention has been made keeping in mind the problems encountered in the related art, and is intended to provide a device for rapidly and efficiently formulating many kinds of liposomes using a small amount of organic solvent, and a device for manufacturing liposomes in which a variety of fluorescent molecules, peptides, membrane proteins and so on are incorporated in the membrane of formulated liposomes, namely reconfigured liposomes. The present inventors designed and manufactured a relatively small mechanical device comprising a cylindrical reaction vessel held in a main body and an eccentric motor. Based on this device, a multipurpose liposome manufacturing device able to stably manufacture a variety of liposomes, and a reconfigured liposome manufacturing device able to manufacture reconfigured liposomes were invented.

### Solution to Problem

Intensive and thorough research into manufacturing liposomes, carried out by the present inventors, led to the development of a device having a relatively simple construction using a cylindrical reaction vessel held in a main body and an eccentric motor thus enabling the manufacturing of a variety of liposomes such as MLV (Multi-Lamellar Vesicles), LUV (Large Unilamellar Vesicles), SUV (Small Unilamellar Vesicles), GUV (Giant Unilamellar Vesicles) and so on.

Thereby, according to a first embodiment of the present invention, a multipurpose liposome manufacturing device comprises a cylindrical reaction vessel held in a main body, an eccentric motor for generating a vortex flow in a solution stored in a reaction space of the reaction vessel, a heater for heating the reaction vessel to a predetermined temperature, an aqueous solution line provided to the reaction vessel so as to introduce an aqueous solution into the reaction space, a first bottle provided on the other end of the aqueous solution line so as to store the aqueous solution, a first pump for transferring the aqueous solution into the reaction space via the aqueous solution line from the first bottle, an inert gas line provided to the reaction vessel so as to introduce an inert gas into the reaction space, a decompression line for decompressing the reaction space, a vacuum pump for performing decompression using the decompression line, a lipid line provided to the reaction vessel so as to introduce an organic solvent having lipid dissolved therein into the reaction space, a second bottle provided on the other end of the lipid line so as to store the organic solvent, a second pump for transferring the organic solvent into the reaction space via the lipid line from the second bottle, and an organic solvent recovery unit for recovering the organic solvent, wherein the inert gas is introduced into the reaction vessel, the eccentric motor is driven to thus generate a vortex flow in the organic solvent having lipid dissolved therein that was put in the reaction space inside the reaction space, the vacuum pump is driven, and the reaction space is decompressed, so that the organic solvent is gasified in the reaction space and recovered by the organic solvent recovery unit, thus forming a thin lipid film on the inner wall of the reaction vessel, and then the inert gas is introduced into the reaction space, the aqueous solution is transferred into the reaction space having the formed thin lipid film, and the eccentric motor is driven to thus generate a vortex flow in the aqueous solution, thereby manufacturing liposomes.

In the present invention, the aqueous solution line branches into a plurality of lines at the end opposite the reaction vessel, and an end of each of the plurality of lines is provided with a water-based bottle for storing a solvent composed mainly of water and a water-based pump for transferring the solvent into the reaction space via the aqueous solution line from the water-based bottle, and the lipid line branches into a plurality of lines at the end opposite the reaction vessel, and an end of each of the plurality of lines is provided with an organic-based bottle for storing a solvent composed mainly of an organic solvent and an organic-based pump for transferring the solvent into the reaction space via the lipid line from the organic-based bottle.

According to a second embodiment of the present invention, a method of manufacturing multipurpose liposomes comprises the following steps of (1) introducing an inert gas into the reaction space of a reaction vessel, and inside the reaction space, while generating a vortex flow in an organic solvent having lipid dissolved therein that was put in the reaction space, decompressing the reaction space, so that the organic solvent is gasified in the reaction space, thus forming a thin lipid film on the inner wall of the reaction vessel, and (2) introducing the inert gas into the reaction space, adding an aqueous solution to the thin lipid film, and generating a vortex flow in the aqueous solution inside the reaction space, thus formulating multipurpose liposomes.

In the present invention, the inert gas line and the decompression line may become the same line by using a three (or more)-way cork.

According to the present invention, the organic solvent having lipid dissolved therein (lipid-organic solvent solution) is stored in the reaction space, and the eccentric motor is driven to generate a vortex flow in the lipid-organic solvent solution, so that the organic solvent is gasified, thereby forming the thin lipid film on the inner wall of the reaction vessel. In conventional methods, an organic solvent having lipid dissolved therein is placed in a round-bottom flask, and the organic solvent is gradually removed under a nitrogen stream or reduced pressure, thus forming a thin lipid film on the bottom of the flask, undesirably requiring much trouble. The present inventors, however, have used a cylindrical vessel instead of the bulky round-bottom flask, and eccentric rotation is imparted to the cylindrical vessel using the eccentric motor attached to the bottom of the cylindrical vessel, thereby generating a vortex flow in the lipid-organic solvent solution inside the vessel. In this state, the vessel and inside of the system are decompressed using the vacuum pump thus gasifying and removing the organic solvent so that a thin lipid film is successfully formed. When a vortex flow is generated in the solution of the reaction space in the cylindrical vessel by driving the eccentric motor, the solution develops upwards along the inner wall of the vessel. As such, when the reaction space is decompressed, the organic solvent can be rapidly removed, thus forming the thin lipid film which is spread widely along the inner wall of the cylindrical vessel.

Also, the aqueous solution such as a buffer is placed in the vessel having the thin lipid film formed on the inner wall thereof, and the eccentric motor is driven to generate a vortex flow in the aqueous solution of the reaction space, thereby hydrating and stripping the thin lipid film, ultimately manufacturing liposomes. The operating conditions of the device including the lipid composition, the solvent composition, the aqueous solution composition, and the volumes of the cylindrical vessel, the temperature, and the eccentric motor driving conditions (i.e. vortex flow properties) are adjusted, thereby allowing a variety of liposomes to be formulated. Conventionally used has been a system for decompressing the reaction space to remove an organic solvent while the reaction vessel is shaken in back and forth (or right and left) directions. In the present invention, the use of the eccentric motor is adopted because the organic solvent is removed while the solution develops well along the inner wall of the vessel, and hence the organic solvent of the inner space can be prevented from bumping and can also be rapidly removed. The eccentric motor may be used for both the removal of the organic solvent and the production of liposomes, thus simplifying the structure of the manufacturing device.

Because there is no need to detach the reaction vessel when liposomes are being produced, it is possible to completely automate the manufacturing device. Furthermore, continuous operation of the device enables liposomes to be mass produced. Also, because the thin lipid film is prepared while generating a vortex flow, the solvent develops well along the inner wall of the vessel. Hence, a small amount of the organic solvent can be used, and thus excessive loads are not imposed on the environment.

Almost all of the processes for manufacturing liposomes take place in a closed system, and thus decompression, deoxygenation, nitrogen substitution, and sterilization may be performed in the reaction space, and also the concerns about the mixing (contamination) of microorganisms are reduced, and thus the present invention can be applied to the manufacture of medicines.

According to this construction, the lipid line and the aqueous solution line are separated, thus facilitating the cleaning of respective lines.

The multipurpose liposomes are a variety of liposomes as mentioned above, and typically include liposomes having multipurpose uses for example (i) liposomes which enclose a water-soluble drug, antigen, antibody, enzyme, gene, etc. in an aqueous phase surrounded with a lipid bilayer membrane, (ii) liposomes in which an oil-soluble drug is enclosed in the lipid bilayer membrane, (iii) liposomes in which functional protein, peptide, biopolymer or the like is held in the membrane using binding, labeling or perforation, (iv) liposomes the membrane surface of which is formulated with PEG•saccharide chains, or (v) non-enclosed liposomes in which any material is not enclosed. The multipurpose liposomes include precursor liposomes of reconfigured liposomes. Such liposomes may be used in various fields including medical science, pharmacy, biology, etc. The present invention pertains to the device able to manufacture multipurpose liposomes.

In the present invention, the aqueous solution line branches into a plurality of lines at the end opposite the reaction vessel, and an end of each of the plurality of lines is equipped with a water-based bottle for storing a solvent composed mainly of water and a water-based pump for transferring the solvent into the reaction space via the aqueous solution line from the water-based bottle, and the lipid line branches into a plurality of lines at the end opposite the reaction vessel, and an end of each of the plurality of lines is equipped with an organic-based bottle for storing a solvent composed mainly of an organic solvent and an organic-based pump for transferring the solvent into the reaction space via the lipid line from the organic-based bottle.

Thereby, a plurality of water-based solvents and a plurality of organic-based solvents may be prepared, and a variety of options for manufacturing liposomes are created, thus enabling a variety of liposomes to be manufactured. Furthermore, because the lines for the water-based solvent and the organic solvent are separated, cleaning of respective lines becomes easy.

According to a third embodiment of the present invention, a reconfigured liposome manufacturing device comprises a cylindrical reaction vessel held in a main body, an eccentric motor for generating a vortex flow in a solution stored in the reaction space inside the reaction space of the reaction vessel, a heater for heating the reaction vessel into a predetermined temperature, a liposome solution line provided to the reaction space so as to introduce a liposome solution into the reaction space, a liposome solution bottle provided on the other end of the liposome solution line so as to store the liposome solution, a liposome pump for transferring the liposome solution into the reaction space via the liposome solution line from the liposome solution bottle, a reaction solution line provided to the reaction vessel so as to introduce a reaction solution for reaction with liposomes into the reaction space, a reaction solution bottle provided on the other end of the reaction solution line so as to store the reaction solution, a reaction solution pump for transferring the reaction solution into the reaction space via the reaction solution line from the reaction solution bottle, and an inert gas line provided to the reaction vessel so as to introduce an inert gas into the reaction space, wherein the inert gas is introduced into the reaction space, the liposome solution and the reaction solution are transferred into the reaction space, and the eccentric motor is driven, so that the liposome solution is reacted with the reaction solution inside the reaction space, thus formulating reconfigured liposomes.

According to a fourth embodiment of the present invention, a method of manufacturing reconfigured liposomes, comprising the following steps of (1) filling a reaction space with an inert gas, and introducing a pre-formulated liposome solution and a reaction solution containing a predetermined material into the reaction space, and (2) generating a vortex flow in the solutions inside the reaction space, so that liposomes are reacted with the material, thus formulating reconfigured liposomes.

The term “reconfigured liposomes” means (i) liposomes in which peptides, proteins (antigen), nucleic acids or the like are bound to the surface of the membrane of pre-formulated liposomes, or (ii) liposomes resulting from fusing pre-formulated liposomes with virus or bacteria. Examples of reconfigured liposomes include liposomes fused with recombinant membrane protein-loaded budded virus, liposomes in which a peptide that is to be entrapped to a specific target portion (e.g. brain) is bound to the surface of the membrane of liposomes, and so on, but the present invention is not limited thereto.

In the present invention, large portions of both the liposome manufacturing devices overlap with each other, and thus the multipurpose liposome manufacturing device may also be used as the reconfigured liposome manufacturing device. If so, for the sake of convenience, functions of both the liposome manufacturing devices may be performed using a single device.

A liposome manufacturing device according to the present invention is characterized in that the multipurpose liposome manufacturing device according to the first embodiment and the reconfigured liposome manufacturing device according to the third embodiment are interchangeably used.

In research conducted by the present inventors, liposomes were successfully formulated by while generating a vortex flow in the organic solvent having lipid dissolved therein inside the reaction space, evaporating the organic solvent, thus forming a thin lipid film, and further by introducing an aqueous solution such as a buffer and generating a vortex flow in the aqueous solution. By using this method, an automated liposome manufacturing device can be provided.

### Advantageous Effects of Invention

According to the present invention, a multipurpose liposome manufacturing device for manufacturing a variety of liposomes such as MLV, LUV, SUV, GUV, etc., can be provided. In the present invention, ultrasound is not used, and temperature control is easy, and thus denaturation of proteins can be prevented, resulting in stable liposomes. Also, a thin lipid film is manufactured while generating a vortex flow in an organic solvent using an eccentric motor, and thus the amount of used organic solvent can be drastically reduced, and the period of time required to manufacture the thin film and the liposomes can be shortened, compared to when using conventional methods.

Furthermore, mass production of liposomes is possible by continuous operation. In addition, a device able to manufacture reconfigured liposomes resulting from binding protein, peptide or the like to the lipid bilayer membrane can be provided.

The use of the liposome manufacturing device according to the present invention makes it easy to manufacture (i) multipurpose liposomes in which water-soluble and oil-soluble drugs, antibodies, enzymes, genes, etc., are enclosed, (ii) reconfigured liposomes in which protein, peptide, DNA, RNA, etc., is bound to the lipid bilayer membrane, and (iii) reconfigured liposomes in which recombinant membrane protein or the like is incorporated in the lipid bilayer membrane.

### DESCRIPTION OF DRAWINGS

FIG. 1 is a schematic view showing a multipurpose liposome manufacturing device;

FIG. 2 is a schematic view showing the end of a water-based line which branches into a plurality of lines;

FIG. 3 is a view showing the end of an organic solvent-based line which branches into a plurality of lines;

FIG. 4 is a schematic view showing the multipurpose liposome manufacturing device in which the end of each of water-based line and organic solvent-based line branches into a plurality of lines, in which this multipurpose liposome manufacturing device may also be used as a reconfigured liposome manufacturing device;

FIG. 5 is a schematic view showing the reconfigured liposome manufacturing device; and

FIG. 6 is a schematic view showing the reconfigured liposome manufacturing device in which the end of each of water-based line and organic solvent-based line branches into a plurality of lines.

### DESCRIPTION OF EMBODIMENTS

Hereinafter, embodiments of the present invention will be described with reference to the drawings. The technical scope of the present invention is not limited to such embodiments, but may be embodied in various forms without departing the purport of the present invention. Also the technical scope of the present invention extends to equivalent ranges.

<Multipurpose Liposome Manufacturing Device>

1. Construction of Multipurpose Liposome Manufacturing Device

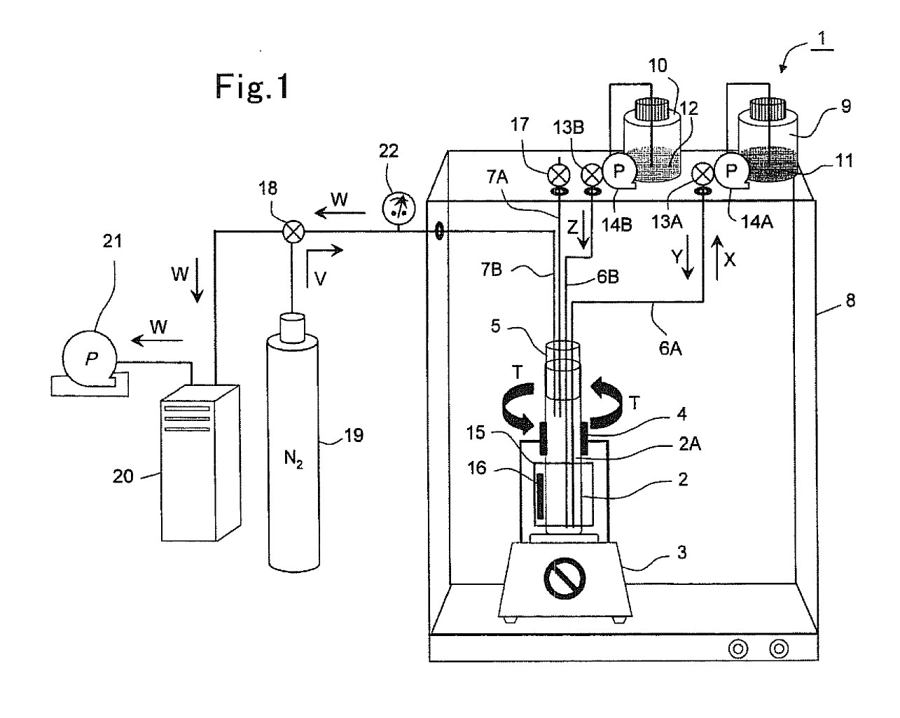

FIG. 1 schematically shows a multipurpose liposome manufacturing device 1, which is simply referred to as a manufacturing device 1 below. The manufacturing device 1 is able to perform operations including forming a thin film of lipid dissolved in chloroform, manufacturing liposomes from the thin lipid film in a predetermined aqueous solution (e.g. an appropriate buffer), and recovering the liposome solution.

The manufacturing device 1 comprises a cylindrical reaction vessel 2 having a reaction space 2A, an eccentric motor 3 with an eccentric shaft for generating a vortex flow in a solution stored in the reaction space 2A inside the reaction space 2A, a heater 15 for heating the reaction vessel 2 to a predetermined temperature, and a temperature sensor 16 for measuring the temperature of the reaction vessel 2. Below, the eccentric motor 3 is simply referred to as a motor 3. An example of the eccentric motor includes a vortex mixer (registered trade name). This unit is received in a chamber 8. The arrow T of FIG. 1 designates the direction of generating a vortex flow in a liquid inside the reaction vessel 2 by the driving of the motor 3.

The manufacturing device 1 is able to manufacture a variety of liposomes by generating a vortex flow in the solution of the reaction space 2A by the driving of the motor 3. Briefly, the manufacturing device 1 is the application of a conventional vortex treatment method.

As described below, the motor 3 is driven to thus generate a vortex flow in the solution inside the reaction space 2A, the reaction space 2A is decompressed, and the organic solvent is removed, thereby forming a thin lipid film. Conventionally, systems have been known in which while a round-bottom flask is shaken or rotated in back and forth (or right and left) directions, the reaction space is decompressed, thus removing the organic solvent. In the present embodiment, however, the organic solvent is removed while a vortex flow is generated in the organic solvent with the motor 3, successfully manufacturing a uniform thin lipid film within a short period of time. This method is advantageous because, when the organic solvent of the internal space develops well upwards along the inner wall of the internal space, it may be prevented from excessive scattering up to the top of the reaction vessel 2. Compared to the conventional method, a much smaller amount of the organic solvent may be used. Furthermore, the motor 3 may be used for both the manufacturing of liposomes and the removal of organic solvent, thus simplifying the structure of manufacturing device 1.

A holder 4 is provided at a position slightly higher than the middle portion of the reaction vessel 2. In the solution of the reaction vessel 2 held by the holder 4, a vortex flow may be generated by the driving of the motor 3. An example of the holder 4 includes a typical clamp. The upper opening of the reaction vessel 2 is closed by a cap 5. A jig for fixing the cap 5 and the reaction vessel 2 may be used.

The cap 5 is provided with lines 6A, 6B, 7A, 7B which perforate it in up and down directions. The lines 6A, 6B, 7A, 7B are formed with a tube having organic solvent resistance and pressure resistance. Among these lines, the line 6A is an aqueous solution line for introducing an aqueous solution 11 into the reaction vessel 2. The aqueous solution includes an appropriate buffer, a Calcein solution, etc. The aqueous solution moves in the direction of arrow Y. The line GA is able to recover the liquid from the reaction space 2A. Upon recovery of the liquid, the liquid moves in the direction of arrow X. One end of the line 6A extends to near the bottom of the reaction space 2A, and the other end thereof is connected to a bottle 9 (first bottle) for storing the aqueous solution 11. Also a pump 14A (first pump) for transferring the aqueous solution 11 into the reaction space 2A from the bottle 9 is provided on the route of the line 6A.

The line 6B is a lipid line. The line 6B is able to mainly supply an organic solvent-based solvent into the reaction space 2A. Upon supply of the solvent, the solvent moves in the direction of arrow Z. One end of the line 6B extends to near the bottom of the reaction space 2A, and the other end thereof is connected to a bottle 10 (second bottle) for storing chloroform 12. A pump 14B (second pump) for transferring the chloroform 12 into the reaction space 2A from the bottle 10 is provided on the route of the line 6B. The chloroform 12 has a lipid dissolved therein that forms the lipid membrane of liposomes.

The line 7A is a ventilation line for communicating the reaction space 2A with external air. The other end of the line 7A extends to the outside of the chamber 8, and is provided with a valve 17.

The line 7B is an inert gas line for supplying an inert gas into the reaction space 2A. The inert gas includes nitrogen gas, argon gas or the like. The line 7B may also be used as a decompression line for decompressing the reaction space 2A by the driving of a vacuum pump 21. The lower ends of both the lines 7A, 7B are positioned near the upper end of the reaction vessel 2 so as not to come into contact with the liquid therein.

A three-way valve 18 is provided on the route of the line 7B. Two paths are formed by the three-way valve 18, and the front end of any one path thereof is connected to a nitrogen bomb 19. Nitrogen gas is supplied in the direction of arrow V. The other path of the three-way valve 18 is provided with an organic solvent recovery unit 20 and the vacuum pump 21. Upon decompression, gas moves in the direction of arrow W. A decompression meter 22 is provided between the three-way valve 18 and the reaction vessel 2 on the line 7B.

In the present embodiment, there is no need to detach the reaction vessel 2 when liposomes are being produced, and also in the process of manufacturing liposomes, decompression, deoxygenation, nitrogen substitution, and sterilization may be carried out in the reaction space 2A. Therefore, the probability of causing contamination due to the mixing of microorganisms may be reduced, and thus the present invention may be applied to the manufacture of medicines.

2. Manufacturing of Multipurpose Liposomes Using Manufacturing Device

A method of manufacturing MIX is described below using a manufacturing device.

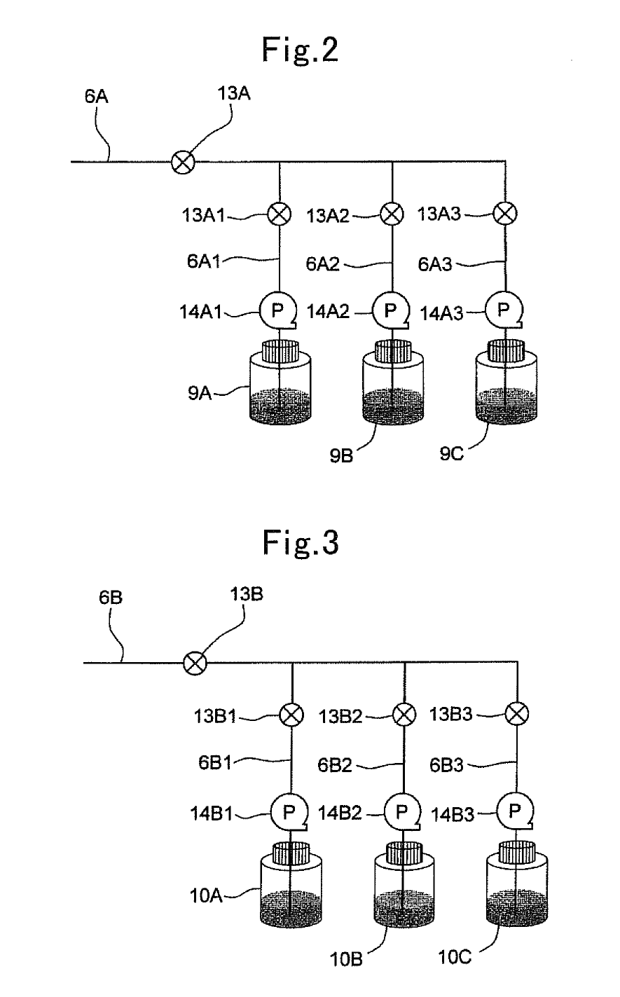

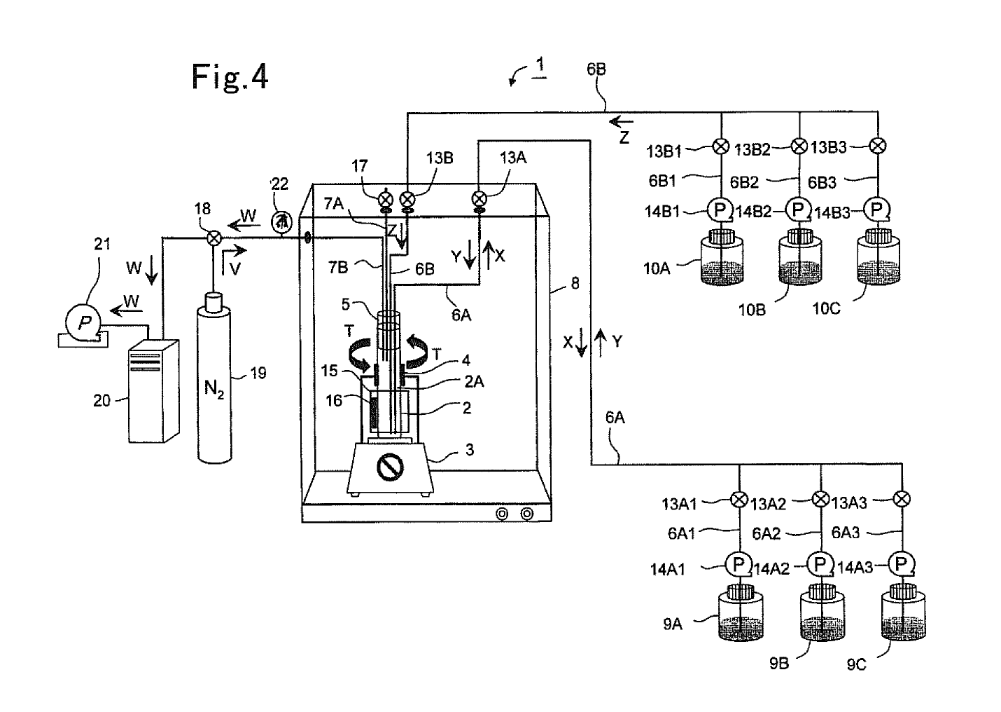

As the manufacturing device used herein, the manufacturing device 1 of FIG. 1 parts of which are changed is used. Specifically, as shown in FIGS. 2 and 3, the ends of two lines 6A, 6B opposite the ends provided to the reaction vessel 2 are respectively equipped with pluralities of water-based lines 6A1, 6A2, 6A3 and organic solvent-based lines 6B1, 6B2, 6B3. This construction is shown in FIG. 4.

The lines 6A, 6B are respectively provided with valves 13A, 13B at positions before these lines branch into three branches. Valves 13A1, 13A2, 13A3 and pumps 14A1, 14A2, 14A3 (water-based pumps) are respectively provided on the routes of the water-based lines 6A1, 6A2, 6A3. The ends of the lines 6A1, 6A2, 6A3 are connected to bottles 9A, 9B, 9C (water-based bottles), respectively. The solution in the bottles 9A, 9B, 9C may be introduced into the reaction vessel 2 by the driving of the pumps 14A1, 14A2, 14A3. When reverse-direction driving is performed, the liquid in the reaction vessel 2 may be recovered into the bottles 9A, 9B, 9C by means of the pumps 14A1, 14A2, 14A3.

The organic solvent-based lines 6B1, 6B2, 6B3 are respectively provided with valves 13B1, 13B2, 13B3 and the pumps 14B1, 14B2, 14B3 (organic-based pumps). The ends of the lines 6B1, 6B2, 6B3 are respectively connected to bottles 10A, 10B, 10C (organic-based bottles). The solution in the bottles 10A, 10B, 10C may be introduced into the reaction vessel 2 by the driving of the pumps 14B1, 14B2, 14B3.

When MLV is manufactured, the recovered liposomes, aqueous solution (including a buffer), and cleaning water are respectively stored in the water-based bottles 9A, 9B, 9C. Also, chloroform having lipid dissolved therein and alcohol are respectively stored in the organic solvent-based bottles 10A, 10B. Upon production of MLV, there is no need to use the bottle 10C.

2-1. Manufacturing of Water-Soluble Material (Low-Molecular-Weight Material)-Enclosed Liposomes

(i) Manufacturing of MLV

2.5 ml of phospholipid (25 μmol dioleoylphosphatidyl choline, and 25 μmol dioleoylphosphatidyl serine) dissolved in chloroform was set in a bottle 10B. Also, 5 ml of 10 Mm HEPES NaOH/175 mM NaCl (pH 7.5) and 100 mM Calcein was set in a bottle 9C. As such, Calcein was used as a marker for checking whether it was incorporated or not in MLV using gel filtration. After the bottles were set, MLV was manufactured. The manufactured MLV solution was recovered into a bottle 9B. The manufacturing steps (common, 0˜25) are shown in Table 1 below. In Table 1, the bottles 9A, 9B, 9C, 10A, 10B, 10C are sequentially defined as bottles 1˜6.

TABLE 1

| | | | Set Item | | Set Item | | Set Item | | Set Item | | Set Item | | Set Item | |
|---|---|---|---|---|---|---|---|---|---|---|---|---|---|---|
| | Operation | Pass | 1 | | 2 | | 3 | | 4 | | 5 | | 6 | |
| Common | | | Jacket | 30 | Heating | 30 | Object | −70 | Vacuum | 30 | Warning | on | N2 | 10 |
| | | | Temp. | | Limit Time | | Vacuum | | Limit | | Sound | | Injection | |
| | | | | | | | Pressure | | Time | | on/off | | Pressure | |
| Step 0 | Interval | 0 | Time from | 10 | | | | | | | | | | |
| | Time before | | operation of | | | | | | | | | | | |
| | Initiation | | start button | | | | | | | | | | | |
| | | | to execution | | | | | | | | | | | |
| Step 1 | Cooling Unit | — | Cooling | | Interval | | Cooling | | | | | | | |
| | Temp. | | Set Temp. | | after | | Limit | | | | | | | |
| | | | | | cooling | | Time | | | | | | | |
| Step 2 | N2 | 0 | Interval | 10 | N2 | on | | | | | | | | |
| | Substitution | | time | | on/off | | | | | | | | | |
| | on/off | | | | | | | | | | | | | |
| Step 3 | Vortex | — | Rotation | | Rotation | | Operating | | | | | | | |
| | 0 | | Rate (rpm) | | (cw/ccw) | | Time (sec) | | | | | | | |
| Step 4 | N2 | 0 | Interval | 10 | N2 | off | | | | | | | | |
| | Substitution | | time | | on/off | | | | | | | | | |
| | on/off | | | | | | | | | | | | | |
| Step 5 | Solution | 0 | Bottle | 5 | Injection/ | Injection | Supply | 100 | Operating | 50 | | | | |
| | Injection/ | | No (1~6) | | Recovery | | (μl/sec) | | Time (sec) | | | | | |
| | Recovery | | | | | | | | | | | | | |
| Step 6 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 7 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 8 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 9 | N2 | 0 | Interval | 10 | N2 | off | | | | | | | | |
| | Substitution | | time | | on/off | | | | | | | | | |
| | on/off | | | | | | | | | | | | | |
| Step 10 | Vortex | 0 | Rotation | 1500 | Rotation | ccw | Operating | 300 | Heater | on | vcu | on | vcu | 3 |
| | 1 | | Rate (rpm) | | (cw/ccw) | | Time (sec) | | on/off | | on/off | | initiation | |
| | | | | | | | | | | | | | time | |
| Step 11 | Vortex | 0 | Rotation | 2500 | Rotation | ccw | Operating | 600 | Heater | on | vtx | on | vcu | 3 |
| | 2 | | Rate (rpm) | | (cw/ccw) | | Time (sec) | | on/off | | continue | | continue | |
| | | | | | | | | | | | on/off | | on/off | |
| Step 12 | N2 | 0 | Interval | 10 | N2 | on | | | | | | | | |
| | Substitution | | time | | on/off | | | | | | | | | |
| | on/off | | | | | | | | | | | | | |
| Step 13 | Solution | 0 | Bottle | 3 | Injection/ | Injection | Supply | 100 | Operating | 50 | | | | |
| | Injection/ | | No (1~6) | | Recovery | | (μl/sec) | | Time (sec) | | | | | |
| | Recovery | | | | | | | | | | | | | |
| Step 14 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 15 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 16 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 17 | N2 | 0 | Interval | 5 | N2 | off | | | | | | | | |
| | Substitution | | time | | on/off | | | | | | | | | |
| | on/off | | | | | | | | | | | | | |
| Step 18 | Vortex | 0 | Rotation | 2000 | Rotation | ccw | Operating | 30 | Heater | on | Vacuum | off | Vacuum | |
| | 3 | | Rate (rpm) | | (cw/ccw) | | Time (sec) | | on/off | | on/off | | Initiation | |
| | | | | | | | | | | | | | Time | |
| Step 19 | Vortex | 0 | Rotation | 2500 | Rotation | ccw | Operating | 30 | Heater | on | vtx | off | vcu | off |
| | 4 | | Rate (rpm) | | (cw/ccw) | | Time (sec) | | on/off | | continue | | continue | |
| | | | | | | | | | | | on/off | | on/off | |
| Step 20 | Solution | 0 | Bottle | 2 | Injection/ | Frequency | Supply | 100 | Operating | 50 | | | | |
| | Injection/ | | No (1~6) | | Recovery | | (μl/sec) | | Time (sec) | | | | | |
| | Recovery | | | | | | | | | | | | | |
| Step 21 | Solution | — | Bottle | | Injection/ | | Supply | | Operating | | | | | |
| | Injection/ | | No (1~6) | | Recovery | | (μl/sec) | | Time (sec) | | | | | |
| | Recovery | | | | | | | | | | | | | |
| Step 22 | N2 | 0 | Interval | 5 | N2 | off | | | | | | | | |
| | Substitution | | time | | on/off | | | | | | | | | |
| | on/off | | | | | | | | | | | | | |
| Step 23 | Step Repeat | — | Repeat point | | | | | | | | | | | |
| | Point | | (Step No) | | | | | | | | | | | |
| Step 24 | Repeat | — | Repeat | | | | | | | | | | | |
| | Frequency | | Frequency | | | | | | | | | | | |
| | | | (n) | | | | | | | | | | | |
| Step 25 | END | | | | | | | | | | | | | |

Respective steps are described below. Although driving and stopping of corks, pumps and so on in detail in respective steps are omitted, they may be easily understood by those skilled in the art based on Table 1.

The common steps are steps which are commonly used for manufacturing a variety of liposomes. In these steps, initial setting is performed.

At step 0, a time (10 sec) required to drive the device is set. At steps 2 and 4, the nitrogen bomb 19 and the reaction vessel 2 are connected by means of the three-way cork 18, and nitrogen gas is supplied for 10 sec. As such, because the cork 17 is opened, surplus nitrogen gas is released to the atmosphere, so that the inside of the reaction vessel 2 is not under high pressure. At step 5, 2.5 mL of lipid dissolved in chloroform is supplied into the reaction vessel 2 from the bottle 10B (5). At step 9, inflow of nitrogen gas is stopped, and waiting for 10 sec is performed.

At steps 10 and 11, while chloroform is evaporated, a thin lipid film is formed on the inner wall of the reaction vessel 2. At these steps, the heater 15 is turned on, and the three-way cork 18 is operated so that the vacuum pump 21 and the reaction vessel 2 are connected, thereby subjecting the reaction vessel 2 to vacuum treatment, and the motor 3 is driven. By driving the motor 3, a vortex flow is generated in the chloroform having lipid dissolved therein that was put in the reaction space 2A inside the reaction space 2A. In this state, the vacuum pump 21 is driven and the reaction space 2A is decompressed, and thus chloroform is gasified in the reaction space 2A, thereby forming the thin lipid film on the inner wall of the reaction vessel 2.

At step 12, the three-way cork 18 is operated so that the nitrogen bomb 19 and the reaction vessel 2 are connected, and the nitrogen gas is supplied into the reaction vessel 2 for 10 sec.

At steps 13˜19, MLV is formulated from the thin film. At step 13, 5 mL of an aqueous solution is supplied into the reaction vessel 2 from the bottle 9C (3). At step 17, nitrogen gas is supplied again into the reaction vessel 2 for 5 sec. At steps 18 and 19, the heater 15 is turned on, and the motor 3 is driven, so that a vortex flow is generated in the aqueous solution in the internal space of the reaction vessel 2.

At step 20, MLV in the reaction vessel 2 is recovered into the bottle 9B (2). At step 22, inflow of nitrogen gas into the reaction vessel 2 is stopped, and waiting for 5 sec is performed. At step 25, the program is stopped.

Also, the step numbers not used in the table are option steps for manufacturing other liposomes.

By performing steps 1˜25, the manufacturing of liposomes of 1 cycle can be completed. 1 cycle requires about 30 min˜60 min, and the cycle is repeated for about 8˜12 hours, thereby manufacturing liposomes of about 10 cycles or more.

The manufactured MLV is compression filtered using a 0.4 μm polycarbonate membrane filter, thus obtaining particles having a size of 0.4 μm or less.

(ii) Phosphorus Quantity

A KH₂PO₄ solution used as a sample and a control was added with 0.4 ml of 10 N H₂SO₄ and heated to 170° C. for 30 min or longer, after which the heated solution was added with 0.1 ml of hydrogen peroxide (30%) and then heated again at 170° C. for 30 min. Subsequently, the sample and the control solution cooled to room temperature were added with 4.6 ml of ammonium molybdate dissolved in 0.25 N H₂SO₄, subjected to vortex treatment, added with 0.2 mL of a coloring reagent, and then heated for 10 min in boiling water. The sample and the control solution were cooled to room temperature, and measured at 830 nm, and phosphorus content in the sample was measured. This phosphorus concentration was determined as a liposome concentration.

(iii) Fraction by Gel Column

The Calcein-enclosed MLV was placed in a Sephadex G-50 column in equilibrium with 10 mM Tris-HCl/150 mM NaCl (pH 7.5), and the Calcein-enclosed MLV was recovered by natural dropping.

(iv) Treatment by Surfactant

500 μL of MLV fraction fractioned by gel column was added with 5 μL of 5% Triton-X100 with stirring, and thus surfactant treatment of MLV was performed. Calcein is a fluorescent material which exhibits concentration quenching properties. Calcein enclosed in MLV has a high concentration, and thus its fluorescence is suppressed, showing a reddish brown color. Upon emission, the Calcein concentration is decreased, thus showing yellowish green colored fluorescence. When fluorescence is exhibited by surfactant treatment, MLV is judged to have been manufactured.

2-2. Manufacturing of Water-Soluble Material (Polymer)-Enclosed Liposomes

This manufacturing process was performed in the same manner as in the manufacturing process of 2-1, with the exception that an antigen (green fluorescent protein), an antibody (anti-green fluorescent material antibody), an enzyme (fluorescence labeled luciferase) or nucleic acid (pER322 vector) was dissolved and used instead of Calcein.

2-3. Manufacturing of Liposomes Having Oil-Soluble Material Enclosed in Membrane Thereof.

This manufacturing process was performed in the same manner as in the manufacturing process of 2-1, with the exception that an oil-soluble material namely diphenylhexatriene was added to the phospholipid dissolved in chloroform.

2-4. Use as Evaporator

In the thin film manufacturing process of 2-1, a mixture of an oil-soluble material and a volatile organic solvent was used instead of the solution of phospholipid dissolved in chloroform. As the oil-soluble material, oleic acid was used, and ethanol was used as the volatile organic solvent.

Test Results

In the case of the water-soluble material, two layers of non-enclosed Calcein and Calcein-enclosed MLV were separated by gel column fractioning, and the Calcein-enclosed MLV was subjected to surfactant treatment. The amplification of fluorescence intensity was detected, from which MLV was confirmed to have been manufactured. Likewise, MLV in which an antigen, antibody, enzyme or nucleic acid was enclosed could be manufactured.

In the case of the oil-soluble material, MLV in which diphenylhexatriene was enclosed in the membrane was manufactured.

Thereby, by use of the automatic multipurpose liposome manufacturing device, supply of a lipid (oil-soluble material) solution, supply of an aqueous solution, manufacturing of a thin lipid film, stripping of the thin film, manufacturing of MLV, and recovery of MLV were proven to be possible.

Also, when the volatile organic solvent was appropriately volatilized, the oil-soluble material could be concentrated. Thereby, concentration of oil-soluble material could be performed in lieu of the formation of thin film in 2-1.

In this way, the manufacturing device 1 according to the present embodiment could be used as an evaporator.

<Reconfigured Liposome Manufacturing Device>

1. Construction of Reconfigured Liposome Manufacturing Device

The term “reconfigured liposome manufacturing device” means a device for manufacturing reconfigured liposomes by reacting pre-formulated liposomes with a predetermined material (e.g. membrane protein, drug, nucleic acid, water-soluble protein, etc.) so that this material is incorporated in the lipid membrane. The reconfigured liposomes include (i) liposomes in which predetermined membrane protein is incorporated in the lipid membrane, (ii) liposomes having a virus-analogous construction in which predetermined membrane protein is incorporated in the membrane, and (iii) liposomes in which a water-soluble protein is bound to the surface of the membrane.

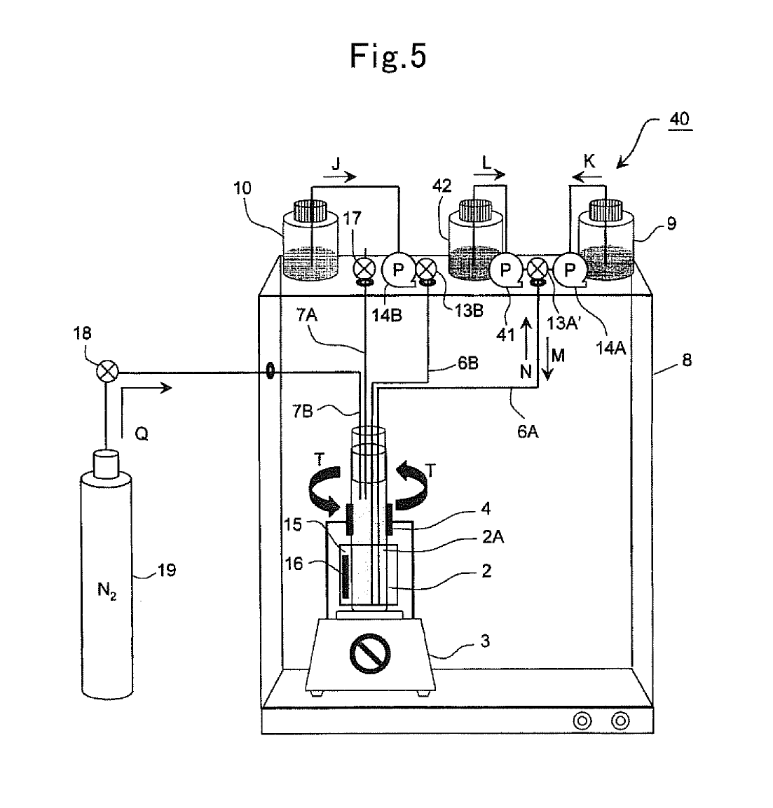

In FIG. 5, the reconfigured liposome manufacturing device 40 is schematically shown, and is referred to as a manufacturing device 40 below. The manufacturing device 40 and the aforementioned manufacturing device 1 may be interchangeably used, as illustrated in FIG. 4. In the case where the present manufacturing device 40 is constructed alone, parts (e.g., an organic solvent recovery unit 20, a vacuum pump 21, etc.) of the manufacturing device 1 are not essentially needed.

In FIG. 5, the same reference numerals are designated for the parts having the same actions as in FIG. 1 and a description thereof is omitted. In the manufacturing device 40, a pre-formulated liposome solution is mixed with a protein solution thus preparing reconfigured liposomes, and the reconfigured liposome solution is then recovered.

A cork 18′ connects or disconnects the nitrogen bomb 19 and the reaction vessel 2. The upper end of a line 6A (aqueous solution line, reaction solution line) is provided with a three-way cork 13A′. The three-way cork 13A′ is connected to a bottle 9 (a reaction solution bottle) and a bottle 42 (an aqueous solution bottle, a recovery bottle). A pump 41 (an aqueous solution pump) is provided between the bottle 42 and the three-way cork 13A′. The pump 41 may supply the solution into the reaction vessel 2 from the bottle 42, or recover the solution into the bottle 42 from the reaction vessel 2. A pump 14A is a reaction solution pump for supplying the reaction solution stored in the bottle 9 into the reaction vessel 2.

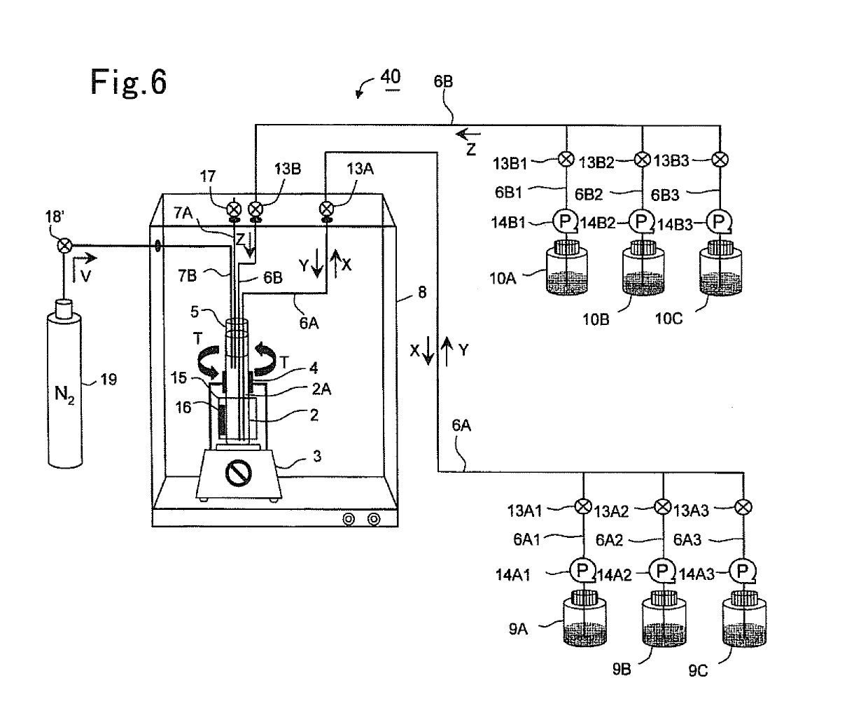

In the drawing, the arrows K, L, M designate a moving direction of the solution when the solution of each of bottles 9, 42 is supplied into the reaction vessel 2. The arrow N designates a moving direction of the solution when the solution of the reaction vessel 2 is recovered into the bottle 42. The arrow J designates a moving direction of the liquid when the liquid of the bottle 10 (liposome solution bottle) is supplied into the reaction vessel 2. The arrow Q shows a gas flow direction when nitrogen gas is supplied into the reaction vessel 2. A line 6B is a liposome solution line, and a pump 14B is a liposome pump. Although not shown in the drawing, the manufacturing device 40 may be constructed as shown in FIG. 6, in which the other end of each of the lines 6A, 6B branches into a plurality of lines as shown in FIGS. 2 and 3.

2. Manufacturing of Reconfigured Liposomes Using Manufacturing Device

A method of manufacturing reconfigured liposomes using the manufacturing device 40 is described. As shown in FIGS. 4 and 6, the same reference numerals are designated for the parts having the same actions and effects, and description thereof is omitted.

2-1. Manufacturing of Peptide-Bound Liposomes

(i) Manufacturing of MLV

A liposome solution used for manufacturing reconfigured liposomes was prepared using the manufacturing device 1. 2.5 mL of phospholipid (10 μmol dioleoylphosphatidyl choline, 10 μmol dioleoylphosphatidyl serine, 4 μmol NHS-distearoylphosphatidyl ethanolamine (NHS-DSPE)) dissolved in chloroform was set in a bottle 10B. Also, 5 mL of 10 mM acetic acid-Na acetate/175 mM NaCl (pH 5.0) was set in a bottle 9C. NHS-DSPE reacts with the amino group of protein or peptide under a weakly alkaline condition (about pH 8.0) thus forming a covalent bond. After the bottles were set, MLV was manufactured. The manufactured MLV solution was recovered into a bottle 9B. The manufacturing steps are based on Table 1.

The manufactured MLV was compression filtered using a 0.4 μm polycarbonate membrane filter, thus obtaining particles having a size of 0.4 μm or less. In order to remove SUV and LUV, MLV was centrifuged (6,000×g, 20 min, 4° C.). The obtained precipitate was suspended in an aqueous solution, and the resulting suspension solution was centrifuged again under the same conditions as above. The above operation was performed five times, and thus the resulting precipitate was suspended in 1 ml of 10 mM acetic acid-Na acetate/175 mM NaCl (pH 5.0) thus obtaining MLV for manufacturing reconfigured liposomes.

Subsequently, the MLV concentration was measured according to the above <(ii) Phosphorus quantity in 2. Manufacturing of multipurpose liposomes using manufacturing device>.

(ii) Binding of Membrane Bonding Type Water-Soluble Peptide to MLV

Using the manufacturing device 40, reconfigured liposomes were manufactured. As the water-soluble peptide which is bound to the lipid bilayer membrane of liposomes, peptide (Asp-Arg-Val-Tyr-Ile-His-Pro-Phe-His-Leu-Val-Ile-His:angiotensinogen's N terminal) composed of 13 amino acids of SEQ ID No:1. The peptide was purchased from Kabushiki Kaisha Peptide Kenkyusho (trade code: 4133-v). The peptide (1 μmol) was dissolved in 2 ml of 10 mM acetic acid-Na acetate/175 mM NaCl (pH 5.0) and thus used as a reaction solution.

The MLV solution in a bottle 9A (a liposome solution bottle), the peptide solution in a bottle 9C (a reaction solution bottle), the reaction aqueous solution (10 mM HEPES-NaOH/175 mM NaCl (pH 8.0)) in a bottle 9B (an aqueous solution bottle) were set, after which reconfigured liposomes were manufactured.

The manufacturing steps (common, 0˜31) are shown in Table 2 below. In Table 2, the bottles 9A, 9B, 9C are sequentially defined as bottles 6, 3, 5.

Depending on actual use forms, alcohol, line cleaning water, etc., may be stored in the bottles 10A, 10B, 10C.

TABLE 2

| | | | Set Item | | Set Item | | Set item | | Set Item | | Set Item | | Set Item | |
|---|---|---|---|---|---|---|---|---|---|---|---|---|---|---|
| | Operation | Pass | 1 | | 2 | | 3 | | 4 | | 5 | | 6 | |
| Common | | | Jacket | 30 | Heating | 30 | Object | −70 | Vacuum | 30 | Warning | on | N2 | 10 |
| | | | Temp. | | limit time | | Vacuum | | Limit | | Sound | | Injection | |
| | | | | | | | Pressure | | Time | | on/off | | pressure | |
| Step 0 | Interval | 0 | Time from | 10 | | | | | | | | | | |
| | Time before | | operating | | | | | | | | | | | |
| | Initiation | | of start | | | | | | | | | | | |
| | | | button to | | | | | | | | | | | |
| | | | execution | | | | | | | | | | | |
| Step 1 | Cooling Unit | — | Cooling | | Interval | | Cooling | | | | | | | |
| | Temp. | | set temp. | | after | | limit | | | | | | | |
| | | | | | cooling | | time | | | | | | | |
| Step 2 | N2 | 0 | Interval | 10 | N2 | on | | | | | | | | |
| | Substitution | | time | | on/off | | | | | | | | | |
| | on/off | | | | | | | | | | | | | |
| Step 3 | Vortex | — | Rotation | | Rotation | | Operating | | | | | | | |
| | 0 | | rate (rpm) | | (cw/ccw) | | Time (sec) | | | | | | | |
| Step 4 | N2 | 0 | Interval | 10 | N2 | off | | | | | | | | |
| | Substitution | | time | | on/off | | | | | | | | | |
| | on/off | | | | | | | | | | | | | |
| Step 5 | Solution | 0 | Bottle | 6 | Injection/ | Injection | Supply | 100 | Operating | 50 | | | | |
| | Injection/ | | No (1~6) | | Recovery | | (μ/sec) | | Time (sec) | | | | | |
| | Recovery | | | | | | | | | | | | | |
| Step 6 | Solution | 0 | Bottle | 3 | Injection/ | Injection | Supply | 100 | Operating | 50 | | | | |
| | Injection/ | | No (1~6) | | Recovery | | (μ/sec) | | Time (sec) | | | | | |
| | Recovery | | | | | | | | | | | | | |
| Step 7 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 8 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 9 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 10 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 11 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 12 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 13 | N2 | 0 | Interval | 10 | N2 | off | | | | | | | | |
| | Substitution | | time | | on/off | | | | | | | | | |
| | on/off | | | | | | | | | | | | | |
| Step 14 | Vortex | 0 | Rotation | 1500 | Rotation | ccw | Operating | 60 | Heater | off | Vacuum | off | Vacuum | |
| | 1 | | rate (rpm) | | (cw/ccw) | | Time (sec) | | on/off | | on/off | | Initiation | |
| | | | | | | | | | | | | | Time | |
| Step 15 | Vortex | 0 | Rotation | 1500 | Rotation | ccw | Operating | 60 | Heater | off | vtx | on | vcu | off |
| | 2 | | rate (rpm) | | (cw/ccw) | | Time (sec) | | on/off | | Continue | | Continue | |
| | | | | | | | | | | | on/off | | on/off | |
| Step 16 | N2 | 0 | Interval | 10 | N2 | on | | | | | | | | |
| | Substitution | | time | | on/off | | | | | | | | | |
| | on/off | | | | | | | | | | | | | |
| Step 17 | Solution | 0 | Bottle | 5 | Injection/ | Injection | Supply | 100 | Operating | 50 | | | | |
| | Injection/ | | No (1~6) | | Recovery | | (μ/sec) | | Time (sec) | | | | | |
| | Recovery | | | | | | | | | | | | | |
| Step 18 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 19 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 20 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 21 | N2 | 0 | Interval | 5 | N2 | off | | | | | | | | |
| | Substitution | | time | | on/off | | | | | | | | | |
| | on/off | | | | | | | | | | | | | |
| Step 22 | Vortex | 0 | Rotation | 2000 | Rotation | ccw | Operating | 30 | Heater | on | Vacuum | off | Vacuum | |
| | 3 | | rate (rpm) | | (cw/ccw) | | Time (sec) | | on/off | | on/off | | Initiation | |
| | | | | | | | | | | | | | Time | |
| Step 23 | Vortex | 0 | Rotation | 2500 | Rotation | ccw | Operating | 30 | Heater | on | vtx | off | vcu | Off |
| | 4 | | rate (rpm) | | (cw/ccw) | | Time (sec) | | on/off | | Continue | | Continue | |
| | | | | | | | | | | | on/off | | on/off | |
| Step 24 | N2 | 0 | Interval | 5 | N2 | off | | | | | | | | |
| | Substitution | | time | | on/off | | | | | | | | | |
| | on/off | | | | | | | | | | | | | |
| Step 25 | Static | 0 | Interval | 600 | | | | | | | | | | |
| | (Interval | | time | | | | | | | | | | | |
| | time) | | | | | | | | | | | | | |
| Step 26 | Solution | 0 | Bottle | 3 | Injection/ | Frequency | Supply | 100 | Operating | 50 | | | | |
| | Injection/ | | No (1~6) | | Recovery | | (μ/sec) | | Time (sec) | | | | | |
| | Recovery | | | | | | | | | | | | | |
| Step 27 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 28 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 29 | Solution | — | Bottle | | Injection/ | | Supply | | Operating | | | | | |
| | Injection/ | | No (1~6) | | Recovery | | (μ/sec) | | Time (sec) | | | | | |
| | Recovery | | | | | | | | | | | | | |
| Step 30 | N2 | 0 | Interval | 5 | N2 | off | | | | | | | | |
| | Substitution | | time | | on/off | | | | | | | | | |
| | on/off | | | | | | | | | | | | | |
| Step 31 | END | | | | | | | | | | | | | |

Respective steps are specified below. Although driving and stopping of corks, pumps and so on in detail in respective steps are omitted, they may be easily understood by those skilled in the art based on Table 2.

The common steps are steps which are commonly used to manufacture a variety of liposomes. In these steps, initial setting is performed.

At step 0, a time (10 sec) required to drive the device is set. At steps 2 and 4, the nitrogen bomb 19 and the reaction vessel 2 are connected by means of a cork 18′, and nitrogen gas is supplied into the reaction vessel 2 for 10 sec. As such, the cork 17 is opened, and thus surplus nitrogen gas is released to the atmosphere, so that the inside of the reaction vessel 2 is not under high pressure. At step 5, 5 mL of the MLV solution is supplied into the reaction vessel 2 from the bottle 9A (6). At step 6, 5 mL of the reaction aqueous solution is supplied into the reaction vessel from the bottle 9B (3). At step 13, the cork 18′ is operated so that the connection between the nitrogen bomb 19 and the reaction vessel 2 is removed, thus stopping the inflow of nitrogen gas, and waiting for 10 sec is performed.

At steps 14 and 15, by driving the motor 3, a vortex flow is generated in the internal solution, thus mixing MLV with the reaction aqueous solution. At these steps, the inside of the reaction vessel 2 becomes a weak alkaline condition. At step 16, the cork 18′ is operated so that the nitrogen bomb 19 and the reaction vessel 2 are connected, and nitrogen gas is supplied into the reaction vessel 2 for 10 sec.

At step 17, 5 mL of the reaction solution is supplied into the reaction vessel 2 from the bottle 9C (5). At step 21, the inflow of nitrogen gas is stopped, and waiting for 5 sec is performed. At steps 22 and 23, the heater 15 is turned on and the motor 3 is operated, so that a vortex flow is generated in the entire solution of the internal space of the reaction vessel 2. In this step, the peptide is coupled with NHS-DSPE of MLV and thus fixed to the surface of the lipid membrane.

At step 24, inflow of nitrogen gas is stopped and waiting for 5 sec is performed, after which waiting for 10 min is performed at step 25. At step 26, the reconfigured liposomes in the reaction vessel 2 is recovered into the bottle 9C (3).

At step 30, the inflow of nitrogen gas into the reaction vessel 2 is stopped, and the process is stopped for 5 sec. At step 31, the program is stopped. Thereby, reconfigured liposomes were manufactured.

Also, the step numbers not used in the table are option steps for manufacturing other liposomes.

(iii) Evaluation of Binding by Fluorescence Intensity Analysis

After the binding reaction between liposomes and peptide, 300 μL of the sample was centrifuged (7,000×g, 20 min, 4° C.). So as not to include precipitates, 200 μL of the supernatant of each solution was recovered. To the supernatant was added 10 mM HEPES NaOH/175 mM NaCl (pH 8.0), 1 mL of which was measured for fluorescence intensity. As such, the excitation wavelength was 495 nm, and the fluorescence wavelength was 520 nm. Compared to the fluorescence intensity of only the peptide, the fluorescence intensity of the non-bound peptide in the binding reaction with MLV is defined as a non-bound ratio, and the ratio of reduced fluorescence intensity is defined as a bound ratio.

2-2. Manufacturing of Protein (Antigen)-Bound Liposomes

This manufacturing process was performed in the same manner as in the manufacturing process of 2-1, with the exception that a protein (antigen) solution was used instead of the peptide solution. As the protein (antigen) solution, a green fluorescent protein dissolved in a buffer was used.

2-3. Manufacturing of Recombinant Proteoliposomes

(i) Manufacturing of MLV

This manufacturing process was performed in the same manner as in the manufacturing process of 2-1, with the exception that a phospholipid (10 μmol dioleoylphosphatidyl choline, 10 μmol dioleoylphosphatidyl serine) was used instead of the phospholipid (10 μmol dioleoylphosphatidyl choline, 10 μmol dioleoylphosphatidyl serine, 4 μmol NHS-distearoylphosphatidyl ethanolamine (NHS-DSPE)), and a buffer 10 mM Tris-HCl/10 mM NaCl (pH 7.5) was used instead of the buffer 10 mM acetic acid-Na acetate/175 mM NaCl (pH 5.0).

(ii) Manufacturing of Recombinant Proteoliposomes (MLV)

This manufacturing process was performed in the same manner as in the manufacturing process of 2-1, with the exception that a reaction buffer 10 mM CH₃COOH—CH₃COONa/10 mM NaCl (pH 4.0) was used instead of the reaction buffer 100 mM Tris-HCl/175 mM NaCl (pH 8.0), and a membrane protein-loaded baculovirus suspension was used instead of the peptide solution.

The membrane protein-loaded baculovirus suspension manufactured by a technique disclosed in a Patent Application (WO2007/094395-A1) by the present inventors was used.

2-4. Use as Bioreactor

An example of use of the manufacturing device 40 as a bioreactor is described.

This manufacturing process was performed in the same manner as in the manufacturing process of 2-3, with the exception that a reaction buffer 10 mM CH₃COOH—CH₃COONa/10 mM NaCl (pH 5.6) was used instead of the reaction buffer 10 mM CH₃COOH—CH₃COONa/10 mM NaCl (pH 4.0), and a phospholipase D (sigma P8804) solution was used instead of the membrane protein-loaded baculovirus suspension.

Test Results

The MLV manufactured by the multipurpose liposome manufacturing device 1 was used for peptide binding, and the model peptide and MLV were bound using the reconfigured liposome manufacturing device 40. Consequently, model peptide-bound MLV having a high bound ratio of model peptide and MLV of 73% could be manufactured.

Likewise, protein (antigen)-bound liposomes, and recombinant proteoliposomes could be manufactured.

By the present process, only the outer compartment of the lipid bilayer was converted from PC (phosphatidyl choline) into PA (phosphatidic acid). In this way, the manufacturing device 40 according to the present embodiment could be used as the bioreactor.

According to the present embodiment, the multipurpose liposome manufacturing device for manufacturing a variety of liposomes such as MLV, LUV, SUV, GUV, etc., could be provided. This manufacturing device does not use ultrasound and facilitates temperature control, and prevents denaturation of protein and so on, resulting in stable liposomes. Also, a device for manufacturing reconfigured liposomes in which proteins, peptides or the like are bound to the lipid bilayer membrane could be provided.

By using the liposome manufacturing device according to the present embodiment, multipurpose liposomes in which drugs, antibodies, enzymes, genes, etc., are enclosed, and also reconfigured liposomes in which pre-formulated liposomes are reacted with a predetermined material (e.g. membrane protein, drug, nucleic acid, water-soluble protein, etc.) so that the material is incorporated in the lipid membrane can be easily provided. Further, this device could be used as a bioreactor.

### DESCRIPTION OF REFERENCE NUMERALS

1—multipurpose liposome manufacturing device
2—reaction vessel
2A—reaction space
3—motor (eccentric motor)
6A—line (aqueous solution line)
6A1, 6A2, 6A3—line (water-based line)
6B—line (lipid line)
6B1, 6B2, 6B3—line (organic-based line)
7B—line (inert gas line, decompression line)
9—bottle (first bottle)
9A, 9B, 9C—bottle (water-based bottle)
10—bottle (second bottle)
10A, 10B, 10C—bottle (organic-based bottle)
14A—pump (first pump)
14A1, 14A2, 14A3—pump (water-based pump)
14B—pump (second pump)
14B1, 14B2, 14B3—pump (organic-based pump)
15—heater
21—vacuum pump
40—reconfigured liposome manufacturing device

1. A multipurpose liposome manufacturing device, comprising:
a cylindrical reaction vessel held in a main body,
an eccentric motor for generating a vortex flow in a solution stored in a reaction space inside the reaction vessel,
a heater for heating the reaction vessel to a predetermined temperature,
an aqueous solution line provided to the reaction vessel so as to introduce an aqueous solution into the reaction space,
a first bottle provided on an end of the aqueous solution line so as to store the aqueous solution,
a first pump for transferring the aqueous solution into the reaction space via the aqueous solution line from the first bottle,
an inert gas line provided to the reaction vessel so as to introduce an inert gas into the reaction space,
a decompression line for decompressing the reaction space,
a vacuum pump for performing decompression using the decompression line,
a lipid line provided to the reaction vessel so as to introduce an organic solvent having lipid dissolved therein into the reaction space,
a second bottle provided on an end of the lipid line so as to store the organic solvent,
a second pump for transferring the organic solvent into the reaction space via the lipid line from the second bottle, and
an organic solvent recovery unit for recovering the organic solvent,
wherein the inert gas is introduced into the reaction vessel, the eccentric motor is driven to thus generate a vortex flow in the organic solvent having lipid dissolved therein that was put in the reaction space inside the reaction space, the vacuum pump is driven, and the reaction space is decompressed, so that the organic solvent is gasified in the reaction space and recovered by the organic solvent recovery unit, thus forming a thin lipid film on the inner wall of the reaction vessel, and then the inert gas is introduced into the reaction space, the aqueous solution is transferred into the reaction space having the formed thin lipid film, and the eccentric motor is driven to thus generate a vortex flow in the aqueous solution, thereby manufacturing liposomes.

2. The multipurpose liposome manufacturing device of claim 1, wherein the aqueous solution line branches into a plurality of lines at an end opposite the reaction vessel, and an end of each of the plurality of lines is equipped with a water-based bottle for storing a solvent composed mainly of water and a water-based pump for transferring the solvent into the reaction space via the aqueous solution line from the water-based bottle, and the lipid line branches into a plurality of lines at an end opposite the reaction vessel, and an end of each of the plurality of lines is equipped with an organic-based bottle for storing a solvent composed mainly of an organic solvent and an organic-based pump for transferring the solvent into the reaction space via the lipid line from the organic-based bottle.

3. A method of manufacturing multipurpose liposomes, comprising:
(1) introducing an inert gas into a reaction space of a reaction vessel, and inside the reaction space, while generating a vortex flow in an organic solvent having lipid dissolved therein that was put in the reaction space, decompressing the reaction space, so that the organic solvent is gasified in the reaction space, thus forming a thin lipid film on the inner wall of the reaction vessel, and
(2) introducing the inert gas into the reaction space, adding an aqueous solution to the thin lipid film, and generating a vortex flow in the aqueous solution inside the reaction space, thus formulating multipurpose liposomes.

4. A reconfigured liposome manufacturing device, comprising:
a cylindrical reaction vessel held in a main body,
an eccentric motor for generating a vortex flow in a solution stored in a reaction space inside the reaction vessel,
a heater for heating the reaction vessel into a predetermined temperature,
a liposome solution line provided to the reaction space so as to introduce a liposome solution into the reaction space,
a liposome solution bottle provided on an end of the liposome solution line so as to store the liposome solution,
a liposome pump for transferring the liposome solution into the reaction space via the liposome solution line from the liposome solution bottle,
a reaction solution line provided to the reaction vessel so as to introduce a reaction solution for reaction with liposomes into the reaction space,
a reaction solution bottle provided on an end of the reaction solution line so as to store the reaction solution,
a reaction solution pump for transferring the reaction solution into the reaction space via the reaction solution line from the reaction solution bottle, and
an inert gas line provided to the reaction vessel so as to introduce an inert gas into the reaction space,
wherein the inert gas is introduced into the reaction space, the liposome solution and the reaction solution are transferred into the reaction space, and the eccentric motor is driven, so that the liposome solution is reacted with the reaction solution inside the reaction space, thus formulating reconfigured liposomes.

5. A method of manufacturing reconfigured liposomes, comprising:
(1) filling a reaction space with an inert gas, and introducing a pre-formulated liposome solution and a reaction solution containing a predetermined material into the reaction space, and
(2) generating a vortex flow in the solutions inside the reaction space, so that liposomes are reacted with the material, thus formulating reconfigured liposomes.

6. (canceled)
